(19) United States
(12) Patent Application Publication
(10) Pub. No.: US 2006/0293840 A1
(43) Pub. Date: Dec. 28, 2006

(54) Airspace partitioning

(76) Inventor: Alexander Klein, Fairfax, VA (US)

Correspondence Address: GEORGE MASON UNIVERSITY;OFFICE OF TECHNOLOGY TRANSFER, MSN 5G5, 4400 UNIVERSITY DRIVE, FAIRFAX, VA, 22030, US

(21) Appl. No.: 11/165,251

(22) Filed: Jun. 24, 2005

(51) Int. Cl. G01C 21/00

(52) U.S. Cl. 701/201; 715/850

(57) ABSTRACT

Disclosed is a mechanism for partitioning an area such as airspace. An area of interest may be overlaid with a grid such as a hexagonal grid. Data related to a metric may be collected in the area of interest. A cell location is then determined for each piece of data. A metric value is then calculated for cells in the grid using the data. Then sub-areas, consisting of one or more cells, may be grown by appending adjacent cells in an attempt to equalize the total metric value between sub-areas.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Grant No: DTFAWA-04-D-00013 awarded by The Federal Aviation Administration.

### BRIEF SUMMARY OF THE INVENTION

In accordance with the invention as embodied and broadly described herein, is a tangible computer-readable medium encoded with a computer program, wherein execution of the computer program by one or more processors causes the one or more processors to execute a series of steps. A first step includes creating a rectangular grid, where the rectangular grid preferably contains at least two rectangular cells arranged in rows and columns. Next, an encapsulating rectangular cell may be located for at least one x,y position using a rectangular cell location mechanism. The encapsulating rectangular cell should contain the x,y position. From the rectangular grid, a hexagonal grid containing a multitude of hexagonal cells may be generated. Using the encapsulating rectangular cell and a rectangular cell to hexagonal cell triplet conversion mechanism, a hexagonal cell triplet may be located. Finally, using the hexagonal cell triplet and a hexagonal cell triplet to hexagonal cell conversion mechanism; an encapsulating hexagonal cell containing the x,y position may be located. In some embodiments of the invention, the hexagonal grid and rectangular grid can cover a geographical map area and the hexagonal cell triplet consists of three adjacent hexagonal cells.

In yet a further aspect of the invention, is a tangible apparatus that comprises a rectangular grid creator, an encapsulating rectangular cell locator, a hexagonal grid generator, a hexagonal cell triplet locator, and an encapsulating hexagonal cell locator. The rectangular grid creator is preferably configured to create a rectangular grid, where the rectangular grid contains at least two rectangular cells arranged in rows and columns. The encapsulating rectangular cell locator is preferably configured to locate an encapsulating rectangular cell containing said x,y position for at least one x,y position using a rectangular cell location mechanism. The hexagonal grid generator is preferably configured to generate a hexagonal grid containing a multitude of hexagonal cells from the rectangular grid, said hexagonal grid. The hexagonal cell triplet locator is preferably configured to locate a hexagonal cell triplet containing the x,y position using the encapsulating rectangular cell and a rectangular cell to hexagonal cell triplet conversion mechanism. The encapsulating hexagonal cell locator is preferably configured to locate an encapsulating hexagonal cell containing the x,y position using the hexagonal cell triplet and a hexagonal cell triplet to hexagonal cell conversion mechanism. The hexagonal grid and said rectangular grid may cover a geographical map area and the hexagonal cell triplet consists of three adjacent hexagonal cells.

A further aspect of the invention is a tangible computer-readable medium encoded with a partitioning computer program, wherein execution of the “partitioning computer program” by one or more processors causes the “one or more processors” to execute a series of steps. An area of interest, covered by a grid consisting of a multitude of grid cells is selected. Next, a seed location for each of a predetermined quantity of sub-areas located within the “area of interest” and initially assigned to an assigned grid cell is determined. The “assigned grid cell” is one of the “multitude of grid cells” and contains a seed location. A predetermined metric is selected. A grid cell value of the predetermined metric for each of the “multitude of grid cells” is calculated. Until all of the “multitude of grid cells” have been assigned to one of the “sub-areas”, the following iterative steps are executed: calculating a sub-area value using the “grid cell value” for each of the “multitude of grid cells” within each of the “sub-areas”; determining a lowest value sub-area, the “lowest value sub-area” being the “sub-area” with the lowest the “sub-area value”; and assigning at least one adjacent the “grid cell” to the “lowest value sub-area”.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated in and form a part of the specification, illustrate an embodiment of the present invention and, together with the description, serve to explain the principles of the invention.

FIG. 1 shows an exemplary Traffic Mass-vs-Workload Chart.

FIG. 2 shows a rectangular and hexagonal grid as per an embodiment of an aspect of the present invention.

FIG. 3A shows sub-cells for a TZ hit location in an odd type hexagonal cell triplet as per an embodiment of an aspect of the present invention.

FIG. 3B, which shows sub-cells for a TZ hit location in an even type hexagonal cell triplet as per an embodiment of an aspect of the present invention.

FIG. 4 illustrates Center growth for eight initial seed locations after 50 iterations using an aspect of an embodiment of the present invention.

FIG. 5 illustrates Center growth for eight initial seed locations after 100 iterations using an aspect of an embodiment of the present invention.

FIG. 6 illustrates Center growth for eight initial seed locations after 200 iterations using an aspect of an embodiment of the present invention.

FIG. 7 illustrates final boundaries for eight Centers using an aspect of an embodiment of the present invention.

FIG. 8 is a flow diagram of an aspect of an embodiment of the present invention.

FIG. 9 is a block diagram of an aspect of an embodiment of the present invention.

FIG. 10 is a flow diagram of an aspect of an embodiment of the present invention.

### DETAILED DESCRIPTION OF THE INVENTION

The present invention is a mechanism for airspace repartitioning with the aim of equalizing traffic load (and, indirectly, the amount of workload), in multiple airspace centers or sectors. Specifically, the present invention may be used to partition the National Airspace System (NAS)-scale airspace utilizing a high-resolution hexagonal grid. The partitioning mechanism may use a traffic mass metric: such as a total aircraft position report (“ETMS TZ hit”) count in each grid cell or airspace Sector/Center, where an airspace Center consists of several airspace Sectors. One skilled in the art will recognize that other metrics may be used in practicing the present invention, including related workload metrics. Also disclosed is a mechanism for processing large amounts of traffic data and creating potential airspace Center boundaries starting from a selected number of seed locations. Aspects of airspace partitioning as described in this disclosure is partially based on the Equalized Traffic Mass principle that total traffic counts for each airspace Center must be about equal, with busy centers being smaller in size than Centers with sparser traffic. The same principle may also be applied to sector boundary design inside a Center. By selecting appropriate seed locations (e.g. around major airports or along major traffic flows), one can control how the mechanism grows the Centers. Applications and extensions of the mechanism may include using a maximum rate of TZ hits in specified interval during a day, such as every 30 minutes (“TZ hit rate”) as a metric, making comparisons of traffic mass difference (“delta-traffic-mass”) for two different days, and considering effects of severe weather patterns and temporal changes in traffic flows on the “elasticity” of the airspace boundaries generated by the present mechanism. Additionally, it is envisioned that the present invention may be used in fast-time simulation tools in conjunction with grid-based air traffic analysis.

Not all of the methods and metrics used for analysis of existing airspace structure can be used for clean-slate airspace design, especially on the macro-scale. In the latter case, the present invention, as an alternative for NAS airspace repartitioning, starts with just Centers as major blocks of airspace. Thus, initially it is not concerned with individual Sectors, so coordination across sector boundaries does not have to be a factor at this stage. Also, workload related metrics such as traffic density, aircraft proximities, etc become “less granular”.

Airspace analysis and partitioning (or re-partitioning) methods based on superimposing traffic flows over a fine grid have been used by a number of researchers. Traditionally, Traffic Density was chosen as a metric, although a range of workload related metrics and workload assessment techniques have also been proposed. While workload analysis may be important, the present invention starts with Traffic Density as a simpler metric. In this disclosure, Traffic Density is also referred to as Traffic Mass, defined as the total aircraft position report (“hit”) count in a grid cell or in an airspace sector/center.

As an approach to studying the relationship between traffic mass and workload, and to have a better justification for using the Traffic Mass metric, several experiments were conducted using TAAM, a sophisticated fast-time air traffic simulator; available from Preston Aviation Solutions Pty Ltd., of Melbourne Australia.

Studying airspace partitioning should not be based on traffic density. It is unlikely that either the US nor European airspace density (defined as traffic mass divided by area), will ever be uniform. Airspace around major metropolitan areas, such as New York or London, will always be very busy, while airspace in remote areas, such as North Dakota, will be less densely populated with airplanes.

The principle that the present invention utilizes for airspace partitioning is that of Equalized Traffic Mass. That is, total traffic counts in each Center, over a selected period, should be equal, so that busier Centers will be smaller and less-busy Centers will be larger in size. (The time period could be an entire day or a smaller period, e.g. 5 busiest hours in the NAS in the afternoon).

ASDI/ETMS data provided by the FAA (and collected by the FAA daily) may be used as part of a rich analysis environment with flight plans, their amendments, 1-minute or more frequent radar position reports (the so-called “TZ hits) etc available for approximately 70,000 flights daily.

To explore alternatives for potential consolidation of all or part of NAS airspace, existing Center or sector boundaries may first be removed in favor of a high-resolution grid overlay. Although different grid types may be used, a preferred embodiment of the present invention uses a less-conventional hexagonal grid as it offers some advantages over rectangular grids. Disclosed is a fast mechanism for processing large amounts of traffic data and then creating airspace center boundaries starting from a selected number of seed locations.

Since it could be difficult to conduct a completely automatic boundary generation, the present invention may be practiced using a simpler, but effective, seeding method. By selecting appropriate seed locations (around major airports or along major flows, for instance), it may be possible to control the optimized partitioning mechanism.

In addition to lateral boundaries, vertical stratification may also be considered. For Center airspace, it may be preferable to ignore all position reports below FL180. Above that, it may be preferable to divide the airspace into two layers (e.g. FL180-FL340 and FL340-FL600) which may each contain an unequal number of new centers.

Temporal changes in traffic flows during the day affect traffic mass distribution in the airspace and with it, the airspace boundaries. These changes were studied by running the mechanism with consecutive one-hour traffic samples extracted from a full day's data. Similarly, effect of severe weather patterns on the “elasticity” of the newly created airspace boundaries can be studied: in the US, storm fronts may result in major traffic flow shifts during the day.

It is important to point out that at this stage; the goal is to disclose some new mechanisms for potential airspace redesign rather than any specific design layouts or the number of Centers.

### BACKGROUND

Numerous air traffic and airspace partitioning analyses have been conducted in the US, Europe and elsewhere using archived traffic data.

An interesting approach to NAS traffic mass analysis is offered by MITRE CAASD IDAT [1]. This tool analyzes the intersections of flight tracks in the NAS. The argument is that the density of intersects, rather than just flight tracks or radar position “hits”, is a good reflection of NAS traffic flow structure and, to an extent, of controller workload in each sector. As such, it could serve as a useful complementary metric in addition to traffic mass per se.

Research conducted by Delahaye et al [2] uses graph partitioning as a method to optimize airspace layouts, where the emphasis is on the route structure of the airspace. Since coordination at sector boundaries is a major contributing factor to controller workload, the objective of the graph partition optimization method is to minimize (or rather, harmonize) traffic flow across sector boundaries. This is achieved by applying an evolutionary algorithm with constraints and finding an optimal allocation of routes (route segments) to airspace sectors.

In terms of airspace partitioning, the approach explored by Trandac, Baptiste and Duong [3] also uses a graph clustering algorithm. In order to take advantage of the well-developed clustering techniques, the airspace is represented by a network of routes rather than by volume. Clearly, there is a strong correlation between the route structure and the traffic complexity in a sector, especially in the European airspace where effects of severe weather en route are less significant.

The work by Donohue and Yousefi [4, 5] proposes a number of new approaches in NAS traffic mass and complexity analysis. First, a hexagonal grid covering NAS airspace is proposed. In clustering applications, hexagonal partitioning is arguably better than rectangular or triangular because it can be expanded smoothly in diagonal directions, not just vertically or horizontally. It is the only partitioning scheme where an individual cell has common edges with neighbors in vertical, horizontal and diagonal directions. In this study, hexagonal cells were created as ATC sectors in TAAM; its workload model was used to estimate traffic complexity in each cell. Also, a clustering algorithm based on linear programming is developed for exploring new ATC sector boundaries that provide even distribution of TAAM workload across multiple sectors.

In [6], Callaham et al analyze traffic flows impacted by weather, although the primary metric is the arrival delay, not traffic mass. The data gathering method is to count the number of “TZ hits” (radar position updates) in each cell of a rectangular grid and to also calculate the intersections of the NCWF polygons (5-min updates of significant weather outlines NAS-wide) so as to assess the impact of severe weather on NAS performance. The concept introduced is Weather Impacted Traffic Index (WITI), i.e. the notion that on a bad weather day, NAS may have performed poorly in absolute terms, but given the circumstances, NAS performance might not have been all that bad.

Research and experiments using the TAAM simulation, indicate that traffic mass is well correlated with complexity/dynamic density/workload type indicators. As an example of correlation between traffic mass and dynamic density, NASA Ames researchers, Sridhar et al [7] have investigated traffic in selected sectors of the Ft Worth Center (ZFW). The resulting graphs representing traffic counts and dynamic density indicators show a strong correlation between the two metrics and a close-to-linear relationship.

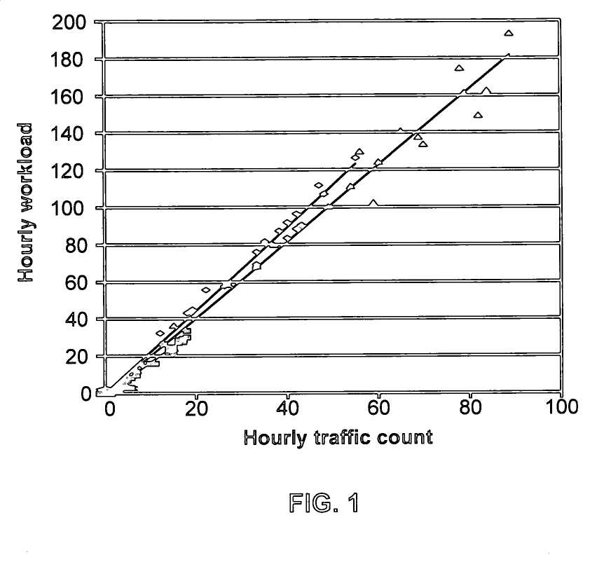

As another illustration of this trend, FIG. 1 shows hourly Traffic Count vs. Workload chart for three ATC sectors in a busy US TRACON, computed from a TAAM simulation. TAAM simulated impact of traffic density, coordination actions, altitude clearances, conflict detection and resolution. These and other factors had different weights and the “workload” was calculated as a weighted, normalized sum of these factors/events in each sector. While the “workload” metric is just a reflection of controller workload as modeled by TAAM, FIG. 1 is nevertheless a good indicator of the two metrics' relationship. From this and similar analyses, it may be concluded that, as a first iteration, traffic mass can indeed be used as an airspace partitioning metric.

The Grid

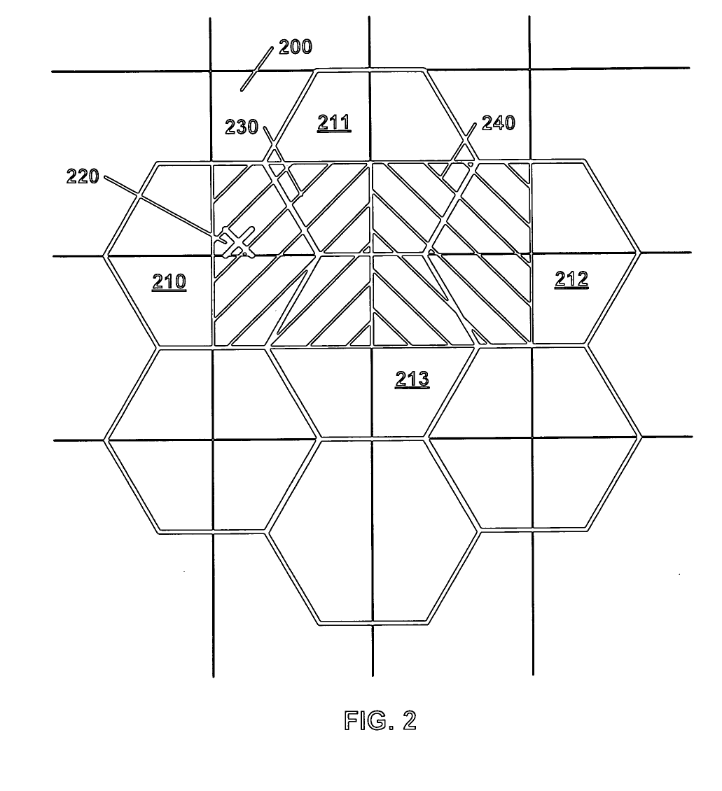

A TZ hit is preferably identified by its coordinates (Latitude/Longitude) and its altitude. Finding the correct vertical layer for each TZ hit is simple, but finding the correct hexagonal cell is a different matter. On a rectangular grid, this task could be trivial: a simple arithmetic division would yield the indices of the cell into which a TZ hit (a cross 220 in FIG. 2) falls. On a hexagonal grid, this is not possible.

FIG. 2: Rectangular and Hexagonal Grid

Because millions of TZ hits may be processing on a hexagonal mesh consisting of thousands of cells for each day of NAS traffic, the algorithm assigning hexagonal cells to TZ hits should be very fast indeed. Therefore, an aspect of the present invention is a new mechanism that ties the hexagonal grid to a rectangular grid (in fact, creates the former from the latter), finds the corresponding rectangular cell for each TZ hit and identifies the corresponding hexagonal cell.

An embodiment of this mechanism is illustrated as follows:
1. A rectangular grid is first created.
2. A hexagonal grid is created from the rectangular grid. Columns 0, 2, 4, . . . of hexagonal cells are created such that the centers of these cells are located at the South-West corners of the rectangular grid cells. In columns 1, 3, 5, . . . the hexagonal cells are adjacent to the neighboring even columns.
3. For each TZ hit (such as 220), the rectangular cell 200 containing the TZ hit 220 is found first from a simple arithmetic relationship between the TZ hit position and the rectangular cell index.
4. With this type of grid pairing, there are only two possible relationships between rectangular and hexagonal cells, A and B, as shown in FIG. 2. The hexagonal cell indices can be derived directly from the rectangular cell index because that is how the hexagonal grid was created.
5. It is now easy to find the correct hexagonal cell 210 for the TZ hit (three different possibilities for type A 230 or type B 240 relationship). In this process, our algorithm subdivides these type A 230 or B 240 cells into smaller rectangular sub-cells to maximize computational performance. Then, for sub-cells on the left and right, the task is again reduced to rectangular sub-cell checks; and it is only for the two sub-cells in the middle that a slightly more complex check (whether the TZ hit is above or below the diagonal hex cell edge) needs to be performed.

This mechanism has proved to be quite fast. Tests show that, for instance, finding the correct hexagonal cell for each of about 1,700,000 TZ hits (NAS traffic for five busiest hours) on a hexagonal grid of 30,000 cells, takes about five seconds in total.

For grid units, it may be preferable to choose degrees (as opposed to nautical miles) for easier calculation. Grid cells may be of slightly uneven size, in that the cells further to the North should be somewhat narrower than the cells closer to the Equator. Further, the cells will be almost, but not completely, symmetrical: they can be slightly narrower or wider. But none of this should have any impact on the airspace subdivision algorithm or results: the only parameter that really matters in this illustrative embodiment is the number of TZ hits in each cell.

The geographical rectangular region studied in this currently described example included all of the current US airspace centers (with oceanic airspace): longitude from 62 to 130 degrees West and latitude from 18 to 50 degrees North. We used a grid consisting of 200 by 150 cells.

Collecting Traffic Mass Metrics

To test the present mechanism, a computer program was developed that that ingests TZ hits for an entire day of for N busiest hours NAS-wide (N could be, say, 5 hours, from 1900 to 2359Z). An altitude interval can be specified as well, e.g. all Class A airspace or a smaller layer such as FL180-340.

Total TZ hit counts were stored for each hexagonal cell. The results were displayed on a screen in color. The use of colors corresponding to the traffic mass in each cell was somewhat subjective but could be adjusted for best visual effect. The increase of traffic mass count in a cell was represented by colors from dark green to brighter green, then yellow, red and finally, magenta.

In higher-altitude pictures, one could clearly see the North-Eastern Triangle (ORD-BOS-MIA), transcontinental tracks, California and Nevada with restricted areas free of traffic, oceanic tracks, traffic across the Gulf of Mexico, and over-water tracks along the Eastern seaboard. It is interesting to note that traffic mass distribution patterns changed in these three altitude intervals. At lower altitudes, traffic was clustered around major airports. At medium to higher altitudes, both the presence of major airports with their approach paths and the en-route traffic (especially shorter-range flights) could be seen. At high altitudes, longer-range and transcontinental flight tracks were most visible.

Center Boundary Formation Method and Algorithm

The present algorithm is somewhat similar to seed growth algorithms used in modeling the growth of crystals, forests, population of bacteria etc; see, for example, the paper by Govindarajan et al [8].

First, select a fixed number of seed locations (for example, 5 or 8 or 15) from which the potential future Centers will be grown. The selection of seed locations may be manual and fairly subjective. However, this simple approach may allow control of the growth and location of the new Centers and to take into account major traffic flows, location of hubs etc.

A practical start is to select several major airports in different parts of the country as the initial seed locations. Obviously, the locations ought to be spread across the area; otherwise it may be difficult to generate Center boundaries that make sense. One skilled in the art will recognize that other methods picking initial of seed locations may be used.

An illustrative example of an embodiment of a Center Growth Algorithm is as follows:
1. “Embryonic” Centers are formed first—each consists of a single hexagonal cell enclosing each of the selected seed locations.
2. The Center with the lowest TZ hit count is determined. That center is allowed to grow one cell layer by finding all cells neighboring its current outer layer (initially, six hexagonal cells around the seed location). All TZ hits in the cells just acquired through this one-layer expansion are added to the Center's total TZ hit count.
3. The Center with the lowest TZ hit count is again identified. It may still be the Center that grew a new cell layer during the previous step, or it may be another Center. This new lowest-TZ-count Center is now allowed to grow another layer.
4. If the lowest-TZ-count Center “bumps” into a neighboring Center (i.e. the cell it wants to acquire already belongs to some other Center), it simply grabs cells from that Center.

5. The procedure is repeated over a sufficient number of iterations which depends on the size of the grid cells. Experiments have shown that approx. 800 iterations work well for the grid with our chosen size, 200×150 cells for US NAS.

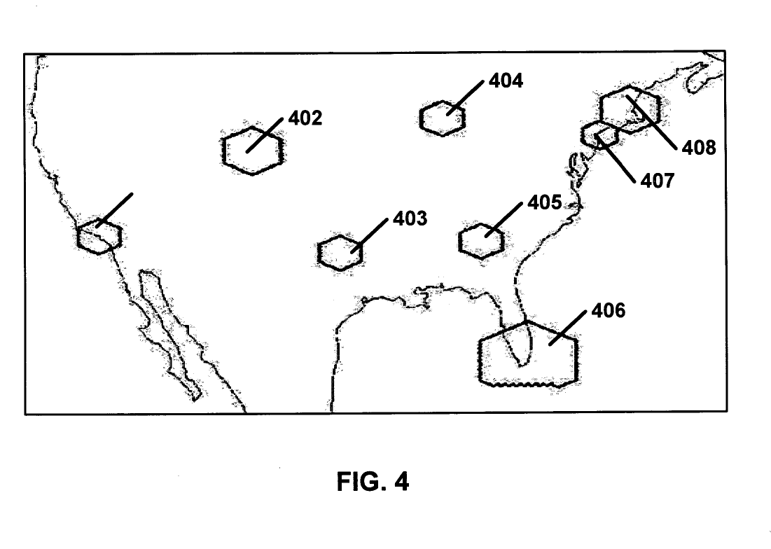

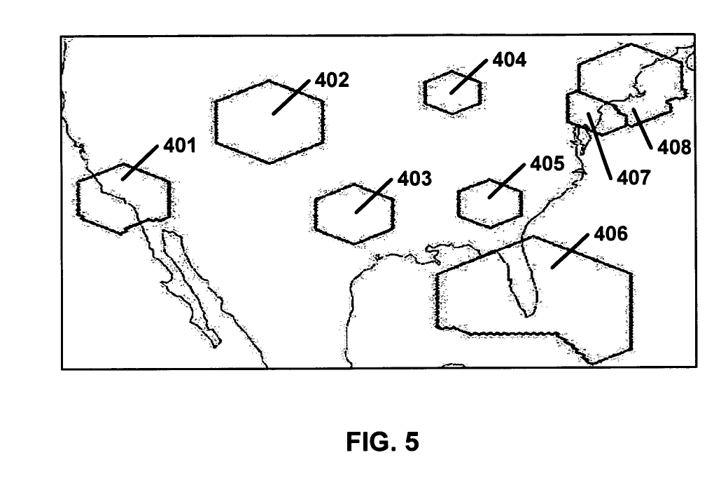

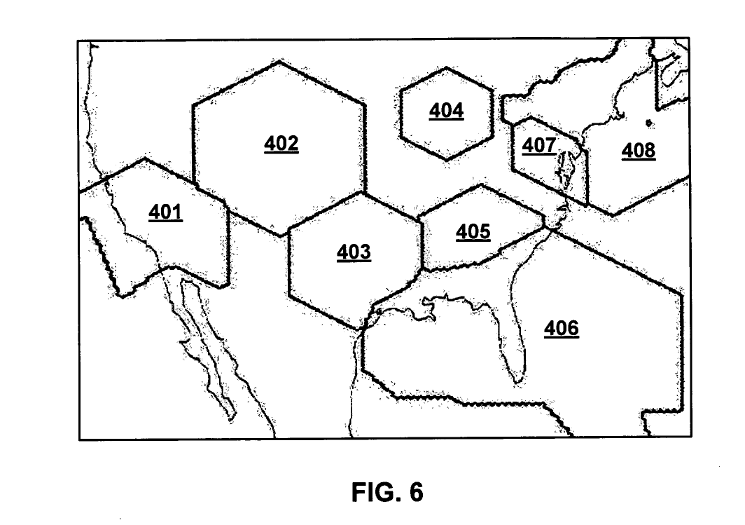

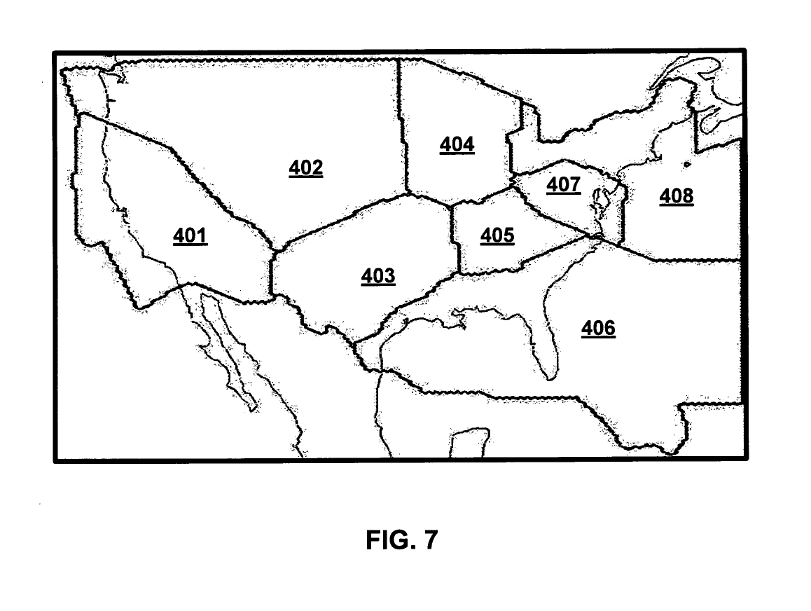

FIGS. 4 through 7 illustrate the Center growth process for eight initial seed locations 401, 402, 403, 404, 405, 406, 407, and 408. FIG. 4 shows center growth after 50 iterations, FIG. 5 shows center growth after 100 iterations, FIG. 6 shows center growth after 200 iterations, and FIG. 7 shows final boundaries for the eight Centers. The vertical boundaries for this example were set as FL180 to FL341.

Note that Center growth is uneven: Centers with higher traffic mass grow slower and sparser-traffic Centers grow in size faster. Because the algorithm may create some unequal traffic mass counts in the newly formed Centers, it may be advantageous to perform a brief equalizing procedure. Experiments have shown that just one or two iterations may be sufficient. In one embodiment of an equalization procedure, each Center may attempt to expand by grabbing cells from the neighboring Centers with higher TZ counts.

An illustrative final result is shown in FIG. 7. Internal boundaries between Centers are shown as thicker lines. The largest-size Center in this case is the one that includes the South-East, Florida and the adjacent part of the Atlantic Ocean. The smallest-size Center is located in the Mid-Atlantic.

Total traffic mass counts in each Center were practically equal: variations typically don't exceed 1%, as the data for the 8-Center partitioning shown above demonstrates:

Limiting Cell Growth with User-Defined Boundary Polygon(s).

One can define one or more boundary polygons and make the algorithm ignore all cells outside those polygons. An example is to load the current US Air Route Traffic Control Centers (ARTCC) boundaries so that the new Centers do not grow outside the US controlled airspace.

The same idea can be used for dividing Centers into Sectors. Having created new Centers, one can select one of them and re-input it as the boundary polygon. Then, one can create a number of seed locations inside this Center and run the algorithm to create Sectors which will have approximately equal traffic mass counts. As a test case, a hypothetical Center may be divided into a number of (such as 3) Sectors of different size but equal traffic mass:

Airspace Boundary Elasticity vis-à-vis Severe Weather Impacts & Temporal Shifts

Airspace partitioning derived from “good-weather” day's traffic may need to be examined with respect to traffic flow changes induced by severe weather en route. For example, if a new Center contains a major flow near its boundary and if during typical weather front passages, the flow shifts across the Center boundary, it may be advantageous to adjust the boundary so that the flow stays within the same Center. Even during the day, changes in traffic flow patterns may warrant an analysis of airspace boundary “elasticity”.

As an example, boundaries generated for one Center in five hourly increments, from 1900 to 2359Z, were run. Variability of the boundaries were clearly visible; it was moderate where traffic density is higher and was greater where traffic density is low.

In additional experiments, it was possible to see the variability of Center boundaries for seven different weather days: from good weather across the NAS, to “medium”, to high weather impact (convective activity in the North-East and South). The same initial seed locations were used for the Centers.

Software Performance

Just as the algorithm finding the appropriate cell for a TZ hit on a hexagonal grid, the center growth algorithm is fast, which obviously is an advantage when processing large amounts of data. As a typical benchmark, a “C” program that was developed took about 17 (seventeen) seconds to ingest 5 million TZ records, populate the 20,000-cell hexagonal grid, and generate Centers from a known number of seed locations.

Analyzing “Delta-Traffic-Mass”

An extension of such a program may compare data from different files. These should represent two equal periods from different traffic days or two different hourly intervals from the same day's traffic. Color schemes (such as shades of gold and blue) could be used to visually differentiate between positive “delta-TZ-counts” (“Period 1 minus Period 2” for each cell) and negative differences. For example, this scheme could be used to show Traffic Mass differences between a good-weather day and a bad-weather day. Precipitation summaries for the days could be shown to help quantify the reasons for traffic density differences. This way, weather impacts, as well as seasonal schedule changes, can be clearly seen.

Such analyses can be useful for a number of reasons. First, effects of severe weather en route can be visualized by comparing ASDI data from a “good-weather day” and a day affected by e.g. major frontal systems. By counting the sum of absolute values of cells (which contain differences in TZ counts), it should be possible, to an extent, quantify the effects of rerouting: greater shifts in traffic patterns will likely result in greater differences in hexagonal cell counts.

Second, it is envisioned that the present invention could be used to perform “as-filed vs. as-flown” traffic comparisons. Using 4D flight profile calculators developed to generate profiles from ASDI FZ records (flight plans as filed), one could “fly” the aircraft—basically, interpolate—to create artificial TZ records at intervals (such as 1-minute intervals). Another method would be to run a fast-time simulation model such as TAAM. The latest TAAM version can generate ASDI-formatted output from a complete NAS-scale simulation run.

One could then use TZ hits from 4D flight-plan profiles or from simulation (i.e. aircraft flying their flight-planned tracks) and compare them with archived TZ hits for the same day (these TZ hits now showing actual tracks). This can produce the as-filed vs. as-flown data for “delta-traffic-mass” analysis. Again, the total of absolute values of TZ count differences for all hexagonal cells should show how closely the actual tracks matched the flight-planned tracks.

Maximum TZ Hit Rate as a Metric

An alternative to the Traffic Mass metric could be the Maximum TZ Hit Rate. One could record the amount of TZ hits in each cell in specified time intervals (e.g. 15, 30, 60 minutes) and find the maximum TZ hits per interval for each cell over a period such as an entire day. This metric is perhaps a better reflection of workload because it includes a temporal element.

Using this new TZ Hit Rate metric, one could partition airspace into a multitude of Centers. Comparing airspace partitioning based on TZ hit rate vs. traffic mass has shown similar but not identical results. Specifically, noticeable local differences may often be observed. As one might expect, the resulting new Center boundaries have also been shown to be different.

Number of Airspace Partitioning Variants for a Given Number of Seeds

There can be a very large number of possible partitioning variants for each fixed number of initial Center seeds. Clearly, there are many other factors, apart from traffic mass or other traffic complexity metrics that might need to be considered. The airspace partitioning software might need to be made interactive to allow the designers to explore the various layout alternatives. Further enhancements of the present invention could turn to some of these additional requirements.

Airspace Redesign and Simulation

Taking the approach described above a step further, one could envisage using the traffic mass count and airspace partitioning algorithm in conjunction with fast-time simulations—the aim in this case would be airspace redesign based on future, not just historical, traffic patterns.

Various airspace designs and flow patterns generated by TAAM or other fast-time simulation model can be analyzed; the model would need to produce output in ASDI or similar format. Traffic mass and “delta-traffic-mass” metrics can be computed, visualized, and related to the airspace partitioning or airspace redesign tasks at hand.

Traffic Complexity Analysis

A current embodiment of the present invention only counts the number of TZ hits in hexagonal cells. However, since ASDI/ETMS TZ records contain the timestamp, flight ID, altitude and speed data, other embodiments could be implemented that utilize that data.

For example, by pre-sorting the traffic data file on (a) flight number and (b) timestamp, the present invention could ingest consecutive series of TZ records belonging to individual flights. This could allow the extraction of additional information such as:
Whether the aircraft were climbing or descending;
Aircraft proximities and potential conflicts; and
Tracks in the vicinity of neighboring Centers or vertical transition areas (e.g. FL180—TRACON to Center transition).

Using this information, one could begin to account for workload related factors: climbing/descending traffic, crossing tracks, vicinity of transition areas all mean higher workload than e.g. straight-and-level traffic on parallel routes. TZ hits belonging to these higher-workload tracks could be assigned a higher weight.

Additionally, embodiments of the present invention could take airspace saturation into account: if, for instance, the traffic mass or the maximum TZ hit rate in a hexagonal cell reaches a certain level, the cell would get a higher-than-1.0 weight coefficient. A non-linear model of the dependency of workload on traffic in congested airspace can be considered.

It is believed that the present invention is capable of efficiently generating a reasonably good approximation of workload impact for any given traffic data set. Additional processing described above is likely to have a moderate effect on the speed of the traffic mass count and airspace partitioning algorithm. And if an entire NAS day of traffic can be processed in several minutes, this would be sufficiently fast for conducting extensive—and interactive—traffic analyses using multiple days, time periods etc.

Summary of Various Embodiments

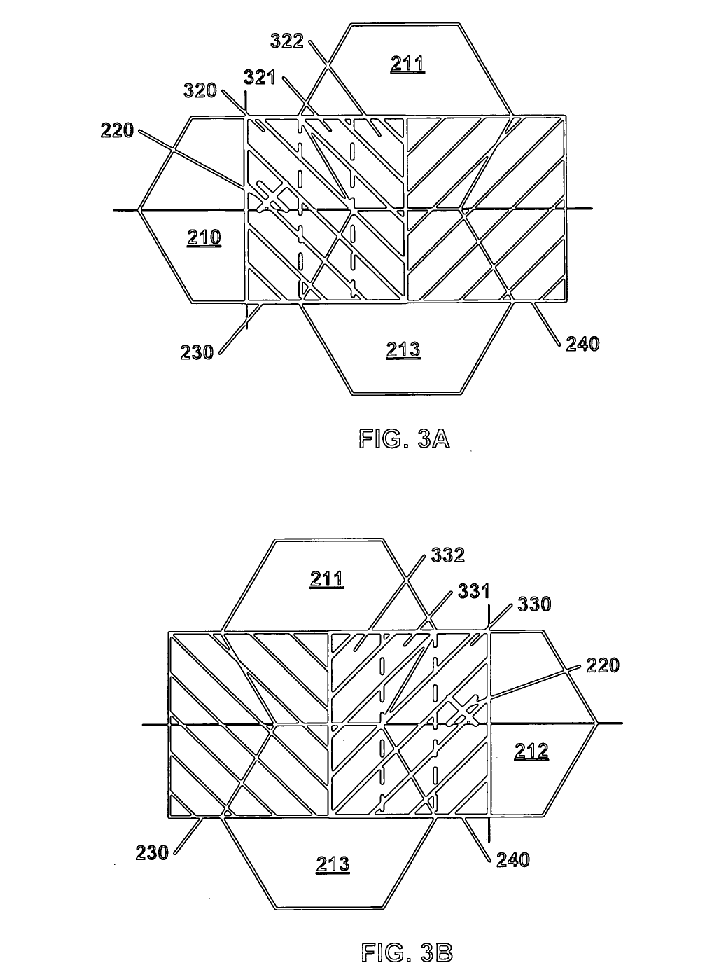

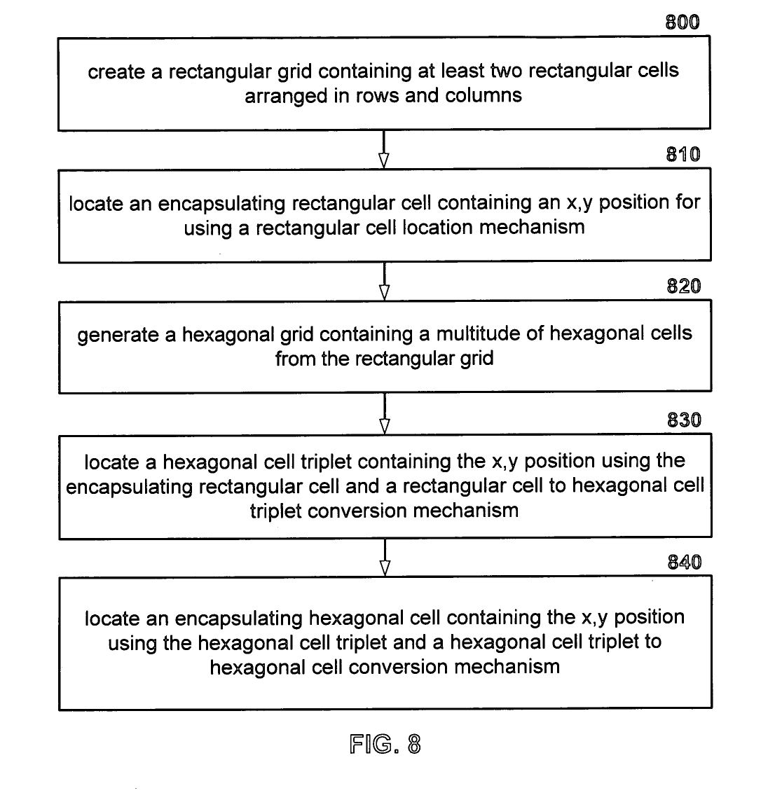

One embodiment of the present invention is a tangible computer-readable medium encoded with a computer program, wherein execution of the computer program by one or more processors causes the one or more processors to execute a series of steps. FIG. 8 is a flow diagram of the series of steps. At step 800, a rectangular grid is created. This rectangular grid preferably contains at least two rectangular cells arranged in rows and columns to a determined size and grid spacing. At step 810, an encapsulating rectangular cell may be located for at least one x,y position using a rectangular cell location mechanism. The encapsulating rectangular cell should contain the x,y position. From the rectangular grid, a hexagonal grid containing a multitude of hexagonal cells may be generated at step 820. Using the encapsulating rectangular cell and a rectangular cell to hexagonal cell triplet conversion mechanism, a hexagonal cell triplet may be located at step 830. A hexagonal cell triplet is comprised of three adjacent hexagonal cells, examples of which may be seen in FIGS. 3A and 3B. Finally, at step 840, using the hexagonal cell triplet and a hexagonal cell triplet to hexagonal cell conversion mechanism; an encapsulating hexagonal cell containing the x,y position may be located. In some embodiments of the invention, the hexagonal grid and rectangular grid can cover a geographical map area and the hexagonal cell triplet consists of three adjacent hexagonal cells.

The hexagonal grid or rectangular grid do not need to be regular. However, although rectangles don't have to be square, it is preferable that they be of a similar size. Similarly, although hexagons could be thinner or thicker than regular hexagons, they should also be of a similar size/shape.

As described earlier, embodiments of this invention are related to tracking aircrafts. In these embodiments, the x,y position may be a reported location of an aircraft. Generally, these points will be acquired at some frequency such as one per minute.

It is envisioned that there may be a multitude of ways in which the rectangular cell location mechanism may locate the encapsulating rectangular cell for an x,y position. One such way may include: determining the column in which the encapsulating rectangular cell is located by dividing the difference of x belonging to the x,y position and the westernmost extent of the rectangular grid by the width of the rectangular cells; and then determining the row in which the encapsulating rectangular cell is located by dividing the difference of y belonging to the x,y position and the southernmost extent of the rectangular grid by the height of the rectangular cells.

The rectangular cell to hexagonal cell triplet conversion mechanism may be applied to the encapsulating rectangular cell and identify the hexagonal cell triplet as either an odd type hexagonal cell triplet (type A) or an even type hexagonal cell triplet (type B).

Referring to FIG. 2, we can see examples of odd and even type hexagonal cell triplets. In this example, the odd type hexagonal cell triplet includes: a leftmost hexagonal cell 210, where the center of the leftmost hexagonal cell 210 is located in the middle of the west edge of encapsulating rectangular cell 230; an upper right hexagonal cell 211, where the center of the upper right hexagonal cell 211 is located in the northeast corner of encapsulating rectangular cell 230; and a lower right hexagonal cell 212, where the center of the lower right hexagonal cell 212 is located in the southeast corner of encapsulating rectangular cell 230. The even type hexagonal cell triplet includes: a rightmost hexagonal cell 212, where the center of the rightmost hexagonal cell 212 located in the middle of the east edge of encapsulating rectangular cell 240; an upper left hexagonal cell 211, where the center of upper left hexagonal cell 211 is located in the northwest corner of encapsulating rectangular cell 240; and a lower left hexagonal cell 213, where the center of lower left hexagonal cell 213 is located in the southwest corner of encapsulating rectangular cell 240.

An embodiment of a hexagonal cell triplet to hexagonal cell conversion mechanism will now be explained. First, a determination of whether an x,y position 220 is determined to be within an odd type hexagonal cell triplet (illustratively shown in FIG. 3A) or within an even type hexagonal cell triplet (illustratively shown in FIG. 3A). FIG. 3A, which shows sub-cells for a TZ hit location in an odd type hexagonal cell triplet, will be referred to help explain the mechanism when the x,y position 220 is determined to be within an odd type of hexagonal cell triplet. FIG. 3B, which shows sub-cells for a TZ hit location in an even type hexagonal cell triplet, will be referred to help explain the mechanism when the x,y position 220 is determined to be within an odd type of hexagonal cell triplet.

When it is determined that x,y position 220 is determined to be within an odd type hexagonal cell triplet (illustratively shown in FIG. 3A), the following steps may be executed to determine which hexagonal cell triplet contains x,y position 220:

First, subdivide the encapsulating rectangular cell 230 located in the odd hexagonal cell triplet (as shown in FIG. 3A) into: a left rectangular sub-cell 320; a right rectangular sub-cell 321; and a center rectangular sub-cell 322. Set leftmost hexagonal cell 320 as the encapsulating hexagonal cell if x,y position 220 is determined to be within the left rectangular sub-cell 320.

Set the upper right hexagonal cell 211 as the encapsulating hexagonal cell if x,y position 220 is determined to be: (1) within the right rectangular sub-cell 322, and (2) within the upper half of right rectangular sub-cell 322. Set the lower right hexagonal cell 213 as the encapsulating hexagonal cell if x,y position 220 is determined to be: (1) within the right rectangular sub-cell 322, and (2) within the lower half of right rectangular sub-cell 322.

Set leftmost hexagonal cell 210 as the encapsulating hexagonal cell if x,y position 220 is determined to be within: (1) within center rectangular sub-cell (2) within the lower side of center rectangular sub-cell 321 and (3) within the leftmost hexagonal cell 210.

Set lower right hexagonal cell 213 as the encapsulating hexagonal cell if x,y position 220 is determined to be within lower right hexagonal cell 213.

Set leftmost hexagonal cell 210 as the encapsulating hexagonal cell if x,y position 220 is determined to be: (1) within the upper side of center rectangular sub-cell 321; and (2) within leftmost hexagonal cell 210. Set upper right hexagonal cell 211 as the encapsulating hexagonal cell if x,y position 220 is determined to be: (1) within the upper side of center rectangular sub-cell 321; and (2) within upper right hexagonal cell 211.

The procedure is very similar if the x,y position 220 is determined to be within a even type hexagonal cell triplet (as shown in FIG. 3B). In this case, the corresponding rectangular cell located in the hexagonal cell triplet should be subdivided into: a left rectangular sub-cell 322; a right rectangular sub-cell 330; and a center rectangular sub-cell 331.

Set the rightmost hexagonal cell 212 as the encapsulating hexagonal cell if x,y position 220 is determined to be within the right rectangular sub-cell 330.

Set upper left hexagonal cell 211 as the encapsulating hexagonal cell if x,y position 220 is determined to be: (1) within left rectangular sub-cell 332; and (2) within the upper half of left rectangular sub-cell 332.

Set the lower left hexagonal cell 213 as the encapsulating hexagonal cell if x,y position 220 is determined to be: (1) within left rectangular sub-cell 332; and (2) within the lower half of left rectangular sub-cell 332.

Set rightmost hexagonal cell 212 as the encapsulating hexagonal cell if x,y position 220 is determined to be: (1) within center rectangular sub-cell 331; (2) within the lower side of center rectangular sub-cell 331; and within rightmost hexagonal cell 212.

Set lower left hexagonal cell 213 as the encapsulating hexagonal cell if x,y position 220 is determined to be within: (1) within center rectangular sub-cell 331; (2) within the lower side of center rectangular sub-cell 331; and (3) within lower left hexagonal cell 213.

Set rightmost hexagonal cell 212 as the encapsulating hexagonal cell if x,y position 220 is determined to be: (1) within the upper side of center rectangular sub-cell 331; and (2) within rightmost hexagonal cell 212.

Set upper left hexagonal cell 211 as the encapsulating hexagonal cell if x,y position 220 is determined to be: (1) within the upper side of center rectangular sub-cell 331; and (2) within upper left hexagonal cell 211.

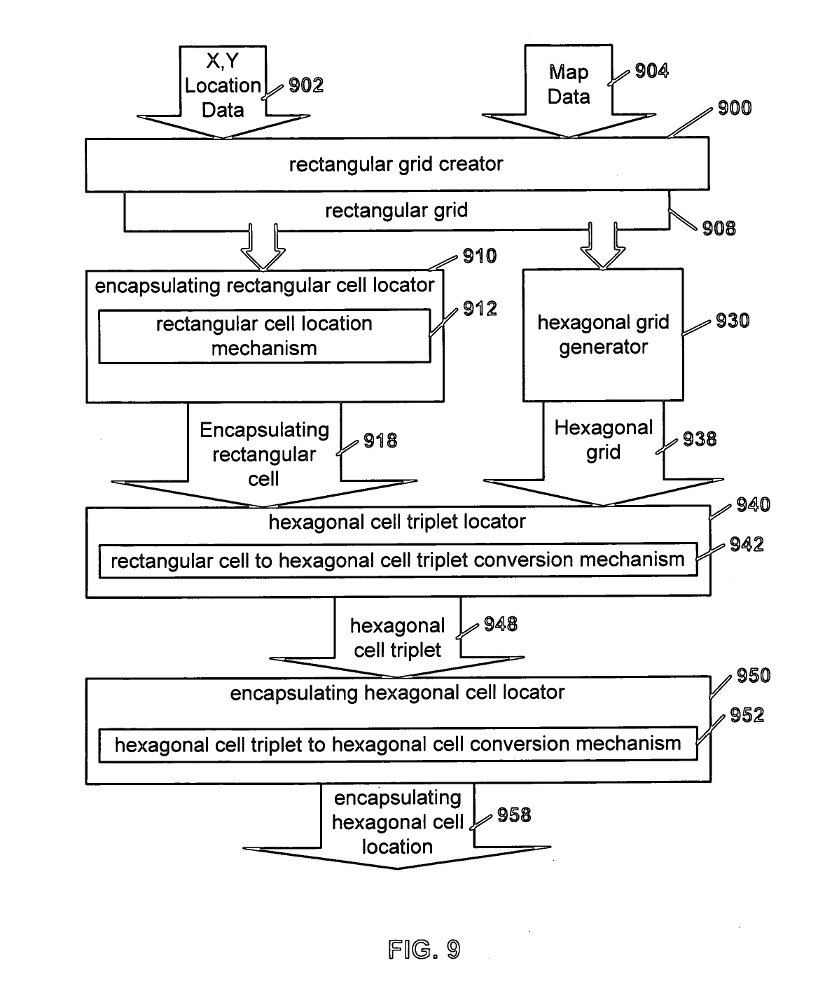

An embodiment of the present invention is shown as an apparatus in FIG. 9. This apparatus includes a rectangular grid creator 900, an encapsulating rectangular cell locator 910, a hexagonal grid generator 930, a hexagonal cell triplet locator 940, and an encapsulating hexagonal cell locator 950. The rectangular grid creator 900 is preferably configured to create a rectangular grid 908, where the rectangular grid 908 contains at least two rectangular cells arranged in rows and columns. The encapsulating rectangular cell locator 910 is preferably configured to locate an encapsulating rectangular cell 918 containing said x,y position for at least one x,y position using a rectangular cell location mechanism 912. The hexagonal grid generator 930 is preferably configured to generate a hexagonal grid 938 containing a multitude of hexagonal cells from the rectangular grid 908. The hexagonal cell triplet locator 940 is preferably configured to locate a hexagonal cell triplet 948 containing the x,y position using the encapsulating rectangular cell 918 and a rectangular cell to hexagonal cell triplet conversion mechanism 942. The encapsulating hexagonal cell locator 950 is preferably configured to locate an encapsulating hexagonal cell location 958 containing the x,y position using the hexagonal cell triplet 948 and a hexagonal cell triplet to hexagonal cell conversion mechanism 952. The hexagonal grid 938 and rectangular grid 908 may cover a geographical map area and the hexagonal cell triplet 948 should consist of three adjacent hexagonal cells. Components 900, 910, 930, 940, 942, 950, and 952 may be built using any number of well known devices such as microprocessors, memory devices, and input/output devices, or with more specialized devices such as an PGA's or ASIC's.

The x,y position inputted into this device may be a reported location of an aircraft. The map data may be electronic map data such as that available from the United states Geologic Survey or FAA. Items 908, 918, 938, 948 and 958 will most likely be stored as electronic data capable of being operated on or transferred over communications channels such as electronic or optical communication channels. The functions in each of these blocks may be performed similarly to those described in previous embodiments.

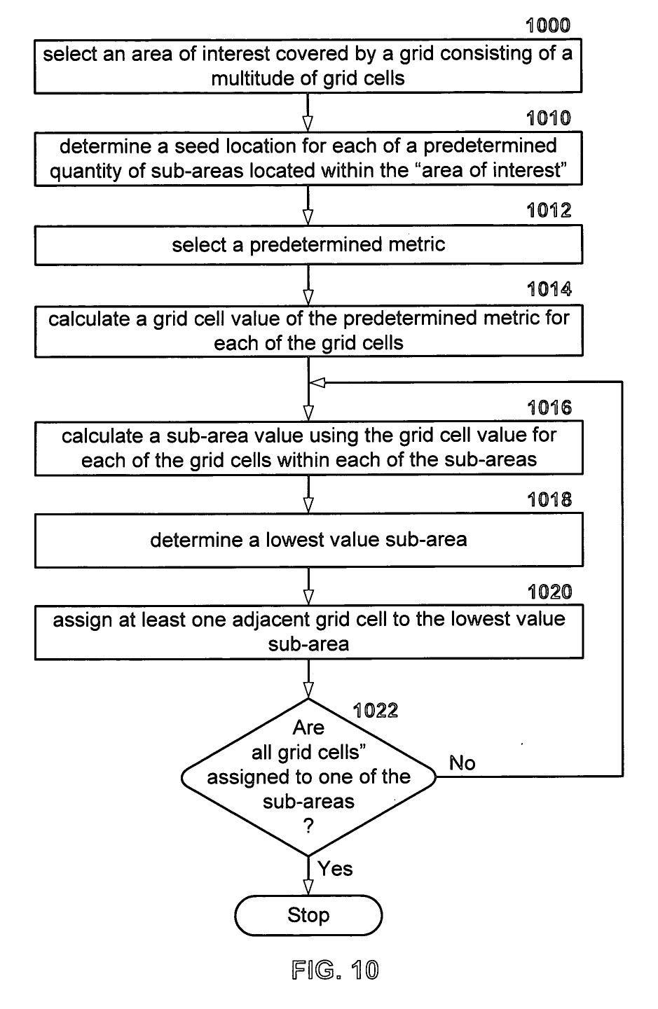

Another aspect of an embodiment of the present invention is a tangible computer-readable medium encoded with a partitioning computer program, wherein execution of the computer program by one or more processors causes the one or more processors to execute a series of steps. FIG. 10 is a flow diagram of the series of steps. At step 1000, an area of interest is selected, where the area of interest is covered by a grid consisting of a multitude of grid cells. The area of interest may be a geographic area such as a geographic that includes navigation routes.

At step 1010, a seed location for each of a predetermined quantity of sub-areas located within the “area of interest” is determined. The initial seed location(s) may be based on the location of a desired characteristic such as: an airport; a city; a zone of interest; a geographical location; a biological reference point; an emergency response facility; or a facility of interest. It may also be advisable to periodically move a seed location to a new location to optimize results. Each of the sub-areas should be initially assigned to an assigned grid cell, where the assigned grid cell is one of the multitude of grid cells and contains a seed location.

At step 1012, a predetermined metric is selected. The metric is quantitative figure related to a physical item such as: weather; aircraft position reports; vehicle position reports; movable assets such as vehicles and ammunition, human resources, population; a biological population; plants; weighted values; or emergency response capabilities. The metric is preferably selected to measure and control the use of a limited resource among an area such as a geographic area.

Next, a grid cell a grid cell value of the predetermined metric should be calculated for each of the multitude of grid cells at step 1014.

Until all of the multitude of grid cells have been assigned to one of the sub-area's (see termination step 1022), the following steps are iteratively performed: (1) calculating a sub-area value using the grid cell value for each of the multitude of grid cells within each of the sub-areas; (2) determining a lowest value sub-area; and (3) assigning at least one adjacent grid cell to the lowest value sub-area. The lowest value sub-area is generally the sub-area with the lowest sub-area value. In some embodiments, the iterative steps may be executed one more time after the termination condition 1022 is satisfied.

Additionally, it may be advantageous to include the additional step of equalizing the sub-areas to within a predetermined tolerance. This may include transferring at least one of the multitude of grid cells residing in a first sub-area to a second adjacent sub-area when the second adjacent sub-area has a lower sub-area value than the first sub-area. The predetermined tolerance may be is a fraction of a metric unit. (In this description, it is important to realize that metric is not a unit definition, but a measurement such as one-half percent of the difference between air traffic mass of two equalized air traffic control centers).

### CONCLUSIONS

Embodiments of the present invention use a Traffic Mass metric for processing massive amounts of traffic data, computing the metrics and displaying the results using a hexagonal rather than rectangular grid. Additional embodiments include an airspace partitioning mechanism based on the Equalized Traffic Mass (which seems a more appropriate name than the Traffic Density). The disclosed Seed Growth-type algorithm generates potential new boundaries for airspace Centers or Sectors while providing practically equal traffic mass distribution in each partition.

The computational performance software implementing these mechanisms is very high, which can be helpful for interactive design involving the analysis of large numbers of traffic data samples. As might be expected, the airspace partitioning algorithm produces some boundary elasticity vis-à-vis temporal changes and weather-related impacts. In the latter case, boundary shifts may be proportional to the weather effects.

Comparing air traffic data from different days, or from different time period of the same day, can provide additional insight into air traffic dynamics. Comparison methods for traffic mass in hexagonal cells may be suitable for quantifying the effects of aircraft rerouting when severe weather en route was present. In this case, 4D flight profile calculators or fast-time simulation tools could produce the “as-planned” tracks for aircraft while ASDI/ETMS data provides the “as-actually-flown” tracks.

Maximum TZ hit rates in hexagonal cells can be computed for specified time intervals as an alternative metric to the traffic mass count. This may reflect traffic dynamics better.

A likely extension of the disclosed invention is to extract additional value from flight tracks in hexagonal cells: altitude change trends, conflicts, proximity to transition altitudes, and possibly non-linear weighting depending on traffic mass in a cell. From this, airspace complexity (and in fact, dynamic density) related metric(s) can be constructed as a weighted sum of the above factors.

Finally, the present invention may also be useful for airspace redesign necessitated by future changes in traffic volumes, flows, and procedures. Fast-time simulation can generate the new tracks from which we can extract traffic-mass and airspace complexity metrics and compare them to baseline data.

The following references have been cited to support statements made in this disclosure:
[1] MITRE CAASD Projects—Intersect Density Analysis Toolset (IDAT) Overview, 2004, at: www.mitrecaasd.org/work/projects_extra/tools.html.
[2] Delahaye, D., M. Schoenauer, and J. Alliot, 1998, Airspace Sectoring by Evolutionary Computation, Proceedings of the IEEE International Congress on Evolutionary Computation, Piscataway, N.J., IEEE Press.
[3] TranDac, H., P. Baptiste, and L. Duong, 2003, Optimized Sectorization Of Airspace With Constraints, 5th Eurocontrol/FAA ATM R&D Seminar, Budapest, Hungary.
[4] Donohue, G. and A. Yousefi, 2004, Temporal & Spatial Distribution of Airspace Complexity for New Methodologies in Airspace Design, Proceedings of the 4th Aviation Technology, Integration, and Operation (ATIO) Conference, AIAA, Chicago, Ill.
[5] Donohue, G., A. Yousefi, and K. Qureshi, 2003, Investigation of Enroute Metrics for Model Validation and Airspace Design Using TAAM, 5th Eurocontrol/FAA ATM R&D Seminar, Budapest, Hungary.
[6] Callaham, M., J. DeArmon, A. Cooper, J. Goodfriend, D. Moch-Mooney, and G. Solomos, 2001, Assessing NAS Performance: Normalizing for the Effects of Weather, 4th USA/Europe ATM R&D Seminar, Santa Fe, N.Mex.
[7] Sridhar, B., K. Sheth, and S. Grabbe, 1998, Airspace Complexity and its Application in Air Traffic Management, 2nd USA/Europe ATM R&D Seminar, Orlando, Fla.
[8] Govindarajan, S., M. Dietze, P. Agarwal, and J. Clark, 2005, A Scalable Algorithm for Dispersing Population, Journal of Intelligent Information Systems, in press.

The foregoing descriptions of the preferred embodiments of the present invention have been presented for purposes of illustration and description. They are not intended to be exhaustive or to limit the invention to the precise forms disclosed, and obviously many modifications and variations are possible in light of the above teaching. The illustrated embodiments were chosen and described in order to best explain the principles of the invention and its practical application to thereby enable others skilled in the art to best utilize the invention in various embodiments and with various modifications as are suited to the particular use contemplated. For example, although the grid in the current disclosure is described in terms of being a hexagonal grid, one skilled in the art will recognize that various aspects and embodiments of the current invention are not so limited and could be practiced using rectangular grid(s), triangular grid(s); or odd-shaped grid(s).

What is claimed is:

1. A tangible computer-readable medium encoded with a partitioning computer program, wherein execution of said “partitioning computer program” by one or more processors causes said “one or more processors” to execute the steps of:
a) selecting an area of interest, said “area of interest” covered by a grid, said “grid” consisting of a multitude of grid cells;
b) determining a seed location for each of a predetermined quantity of sub-areas, each of said “sub-areas” located within said “area of interest”, each of said “sub-areas” initially assigned to an assigned grid cell, said “assigned grid cell” being one of said “multitude of grid cells”, said “assigned grid cell” containing a seed location;
c) selecting a predetermined metric;
d) calculating a grid cell value of said predetermined metric for each of said “multitude of grid cells”; and
e) until all of said “multitude of grid cells” have been assigned to one of said “sub-areas”, iteratively:
i) calculating a sub-area value using said “grid cell value” for each of said “multitude of grid cells” within each of said “sub-areas”;
ii) determining a lowest value sub-area, said “lowest value sub-area” being said “sub-area” with the lowest said “sub-area value”; and
iii) assigning at least one adjacent said “grid cell” to said “lowest value sub-area”.

2. A tangible computer-readable medium according to claim 1, further including the step of equalizing said “sub-areas” to within a predetermined tolerance.

3. A tangible computer-readable medium according to claim 2, wherein said step of “equalizing said ‘sub-areas’” includes transferring at least one of said “multitude of grid cells” residing in a first sub-area to a second adjacent sub-area when said “second adjacent sub-area” has a lower said “sub-area value” than said “first sub-area”.

4. A tangible computer-readable medium according to claim 1, wherein at least one said “seed location” is moved to a new location.

5. A tangible computer-readable medium according to claim 1, wherein the iterative steps of claim 1 are repeated at least one more time.

6. A tangible computer-readable medium according to claim 1, wherein said “area of interest” is a geographic area.

7. A tangible computer-readable medium according to claim 1, wherein said “metric” includes at least one of the following:
a) aircraft position reports;
b) vehicles position reports;
c) movable assets;
d) human resources;
e) population;
f) a biological population;
g) plants;
h) weighted values; and
i) emergency response capabilities.

8. A tangible computer-readable medium according to claim 1, wherein an initial said “seed location” is based on the location of at least one of the following:
a) an airport;
b) a city;
c) a zone of interest;
d) a geographical location;
e) a biological reference point;
f) an emergency response facility; and
g) a facility.

9. A tangible computer-readable medium according to claim 1, wherein said “grid” is at least one of the following:
a) a hexagonal grid;
b) a rectangular grid,
c) a triangular grid; and
d) an odd-shaped grid.

10. A tangible computer-readable medium according to claim 1, wherein said “predetermined tolerance” is a fraction of a metric unit.

11. A tangible partitioning apparatus, comprising:
a) A computer containing one or more processors; and
b) a computer-readable medium encoded with a partitioning computer program, wherein execution of said “partitioning computer program” by said “one or more processors” causes said “one or more processors” to execute the steps of:
i) selecting an area of interest, said “area of interest” covered by a grid, said “grid” consisting of a multitude of grid cells;
ii) determining a seed location for each of a predetermined quantity of sub-areas, each of said “sub-areas” located within said “area of interest”, each of said “sub-areas” initially assigned to an assigned grid cell, said “assigned grid cell” being one of said “multitude of grid cells”, said “assigned grid cell” containing a seed location;
iii) selecting a predetermined metric;
iv) calculating a grid cell value of said predetermined metric for each of said “multitude of grid cells”; and
v) until all of said “multitude of grid cells” have been assigned to one of said “sub-areas”, iteratively:
(1) calculating a sub-area value using said “grid cell value” for each of said “multitude of grid cells” within each of said “sub-areas”;
(2) determining a lowest value sub-area, said “lowest value sub-area” being said “sub-area” with the lowest said “sub-area value”; and
(3) assigning at least one adjacent said “grid cell” to said “lowest value sub-area”.

12. A tangible computer-readable medium according to claim 11, further including the step of equalizing said “sub-areas” to within a predetermined tolerance.
A tangible computer-readable medium according to claim 12, wherein said step of “equalizing said ‘sub-areas’” includes transferring at least one of said “multitude of grid cells” residing in a first sub-area to a second adjacent sub-area when said “second adjacent sub-area” has a lower said “sub-area value” than said “first sub-area”.

13. A tangible computer-readable medium according to claim 11, wherein at least one said “seed location” is moved to a new location.

14. A tangible computer-readable medium according to claim 11, wherein the iterative steps of claim 11 are repeated at least one more time.

15. A tangible computer-readable medium according to claim 11, wherein said “area of interest” is a geographic area.

16. A tangible computer-readable medium according to claim 11, wherein said “metric” includes at least one of the following:
a) aircraft position reports;
b) vehicles position reports;
c) movable assets (e.g. vehicles, ammunition);
d) human resources (troops, personnel);
e) population;
f) a biological population;
g) plants;
h) weighted values; and
i) emergency response capabilities.

17. A tangible computer-readable medium according to claim 11, wherein an initial said “seed location” is based on the location of at least one of the following:
a) an airport;
b) a city;
c) a zone of interest;
d) a geographical location;
e) a biological reference point;
f) an emergency response facility; and
g) a facility.

18. A tangible computer-readable medium according to claim 11, wherein said “grid” is at least one of the following:
a) a hexagonal grid;
b) a rectangular grid,
c) a triangular grid; and
d) an odd-shaped grid.

19. A tangible computer-readable medium according to claim 11, wherein said “predetermined tolerance” is a fraction of a metric unit.
